(19) United States
(12) Patent Application Publication
(10) Pub. No.: US 2007/0092619 A1
(43) Pub. Date: Apr. 26, 2007

(54) Leavened snack products and processes for producing the same

(76) Inventors: Luping Ning, St. Louis, MO (US); Matthew K. McMindes, Chesterfield, MO (US); Philip A. Witte, West Alton, MO (US)

Correspondence Address: SOLAE, LLC, PO BOX 88940, ST. LOUIS, MO, 63188, US

(21) Appl. No.: 11/256,119

(22) Filed: Oct. 21, 2005

(51) Int. Cl. A21D 10/00

(52) U.S. Cl. 426/549

(57) ABSTRACT

The present disclosure generally relates to high protein leavened snack products including vegetable protein material and a non-vegetable protein material and processes for making high protein leavened snack products. More particularly, the present disclosure relates to high protein leavened snack products including soy protein materials and protein from meat, meat by-products, or dehydrated meat material.

### FIELD OF THE DISCLOSURE

The present disclosure generally relates to high protein leavened snack products including vegetable protein materials and non-vegetable protein materials and processes for making high protein leavened snack products. More particularly, the present disclosure relates to high protein leavened snack products including soy protein materials and protein from meat, meat by-products, and/or dehydrated meat materials.

### BACKGROUND OF THE DISCLOSURE

In recent years, it has become common for consumers to choose foods that are convenient and tasty. Convenient or ready-to-eat foods tend to be nutritionally unbalanced as they may be high in fat and carbohydrates and low in protein. In particular, it is appreciated that the high fat and calorie load of such food products can contribute to obesity and various chronic diseases, such as coronary heart disease, stroke, diabetes, and certain types of cancer.

Generally, vegetable protein materials are eaten in the form of beans or other natural products, but enriched sources such as flour, concentrations, and isolates of defatted oilseed, especially soy, have been developed for use as food ingredients. Soy protein products, in particular, can be good sources for protein because, unlike some other beans, soy offers a “complete” protein profile. Soybeans contain all the amino acids essential to human nutrition, which must be supplied in the diet because they cannot be synthesized by the human body. Additionally, soybeans have the highest protein content of all cereals and legumes.

It is known that many of these vegetable products, such as soy protein products, contain little or no cholesterol. For decades, nutritional studies have indicated that the inclusion of soy protein in the diet actually reduces serum cholesterol levels in people who are at risk. Further, the higher the cholesterol, the more effective soy proteins are in lowering that risk.

While the advantages of vegetable protein materials and, in particular, soy protein materials, are many, consumers also desire food products that have the pleasing tastes and flavors of non-vegetable protein materials. Non-vegetable protein materials such as meat, meat-by products, and dehydrated meat materials, such as beef jerky-type products, are popular food items from a taste perspective, and also provide high levels of protein necessary essential to human nutrition. While such non-vegetable protein materials are generally acceptable from a nutrition standpoint, in many instances they may not be readily converted into products that are convenient, ready-to-eat, portable snack products. Further, such products typically do not contain significant amounts of highly nutritional vegetable protein materials, such as soy protein, that possess the numerous benefits described above.

As is evident from the foregoing, a need exists in the industry for a convenient, ready-to-eat leavened snack product that provides a high concentration of protein and a pleasing taste and texture. Additionally, it would be beneficial if the food product includes both vegetable protein materials and non-vegetable protein materials.

### SUMMARY OF THE DISCLOSURE

The present disclosure relates to high protein leavened snack products. The present disclosure also provides processes for preparing the high protein leavened snack product. The high protein leavened snack products described herein include both vegetable protein materials and non-vegetable protein materials. In one embodiment, the high protein leavened snack products include soy protein isolates and meat protein.

Briefly, therefore, the present disclosure is directed to a process for producing a leavened snack product. The process includes forming a dough comprising from about 0.1% (by weight dough) to about 60% (by weight dough) vegetable protein material and from about 0.1% (by weight dough) to about 60% (by weight dough) non-vegetable protein material. The dough is separated into individual wafers and the dough is heated to produce the leavened snack product.

Another aspect of the present disclosure is a leavened snack product including from about 0.2% (by weight leavened snack product) to about 80% (by weight leavened snack product) vegetable protein; from about 0.2% (by weight leavened snack product) to about 30% (by weight leavened snack product) non-vegetable protein; and from about 1% (by weight leavened snack product) to about 6% (by weight leavened snack product) moisture.

Other objects and features will be in part apparent and in part pointed out hereinafter.

### DETAILED DESCRIPTION OF THE DISCLOSURE

The present disclosure is generally directed to high protein leavened snack products and processes for their manufacture. Specifically, the present disclosure relates to high protein leavened snack products including both vegetable protein material and non-vegetable protein material. It has been found that a high protein leavened snack product including high levels of soy protein materials and high levels of non-vegetable protein such as protein from meat, meat by-products, and/or dehydrated meat material may be produced according to the processes described herein. Additionally, the leavened snack products have a pleasant taste, flavor, and texture.

The high protein leavened snack products of the present disclosure may be produced by a variety of processes as noted herein. Although the precise steps may vary, generally the processes described herein for producing high protein leavened snack products involve forming a dough including vegetable protein materials and non-vegetable protein materials for use as the starting material. The processes described herein also include such steps as separating the dough into individual wafers, and heating the individual wafers to produce the leavened snack product. Various additional and/or alternative processes may also include sheeting the dough and separating the sheeted dough into individual wafers. As noted above, however, the various processes for producing the leavened snack product all generally utilize a dough as the starting material. The dough and components thereof are discussed in detail below.

Vegetable Protein Materials for Use in the Dough

As noted above, the various processes for producing the high protein leavened snack products described herein generally involve first forming a dough including vegetable protein material. Preferably, the dough includes from about 0.1% (by weight dough) to about 60% (by weight dough) vegetable protein material. More preferably, the dough includes from about 2% (by weight dough) to about 50% (by weight dough) vegetable protein material. Most preferably, the dough includes fiom about 5% (by weight dough) to about 45% (by weight dough) vegetable protein material.

Common vegetable protein materials for use in the leavened snack product include proteins from cereal grains (e.g., wheat, corn, rice, oats, barley, rye, sorghum, etc.). Other common vegetable protein materials for use in the leavened snack product include proteins from legumes (e.g., lupine, favabean, pea bean, mung bean, field pea, lima bean, lentil, chickpeas, etc.). Still other common vegetable protein materials for use in the leavened snack product include proteins from other oilseeds (e.g., soybean, sunflower, canola, peanut, cottonseed, flaxseed, linseed, sesame seed, etc.). Preferably, the dough includes a soy protein material. Suitable soy protein materials include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and grinding the soybean and typically contain less than about 65% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the comminuted materials and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 μm to about 1000 μm. Soy meal generally has a particle size of greater than about 1000 μm.

In one embodiment, the vegetable protein material in the dough is soy flour or soy protein concentrate. Soy protein concentrates typically contain about 65% (by weight dry basis) to less than 90% (by weight dry basis) soy protein, with the major non-protein component being fiber. Soy protein concentrates are typically formed from defatted soy flakes by washing the flakes with either an aqueous alcohol solution or an acidic aqueous solution to remove the soluble carbohydrates from the protein and fiber. Suitable commercially available soy protein concentrates for use in the dough include, for example, Promine® DS, Procon® 2000, and Procon® L, available from The Solae Company, St. Louis, Mo.

In a preferred embodiment, the vegetable protein material in the dough is soy protein isolates, which are highly refined soy protein materials. Specifically, soy protein isolates are processed to contain at least 90% (by weight dry basis) soy protein and little or no soluble carbohydrates or fiber. Soy protein isolates are typically formed by extracting soy protein and water soluble carbohydrates from defatted soy flakes or soy flour with an alkaline aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein (about pH 4.5) to precipitate the protein from the extract. The precipitated protein is separated from the extract, which retains the soluble carbohydrates, and is dried after being adjusted to a neutral pH or is dried without any pH adjustment. Numerous variations of the standard methods described above for producing a soy protein isolate are also known to those of skill in the art. For example, some processes utilize ultrafiltration membranes to separate the desired soy protein materials from the less desirable materials. Other processes may substitute water for the aqueous alkaline solution during the extraction step. The exact procedure used to produce the soy protein isolates utilized in the dough is not narrowly critical and suitable processes are known to one of skill in the art.

Additionally, numerous commercially available soy protein isolates can be used as a component of the dough described herein. Suitable commercially available soy protein isolates for use in the dough include, for example, SUPRO® 670, SUPRO® 661, SUPRO® EX38, and SUPRO® 500E, available from The Solae Company, St. Louis, Mo.

Non-Vegetable Protein Materials for Use in the Dough

As noted above, the dough used in producing the high protein leavened snack product also includes non-vegetable protein material. Preferably, the dough includes from about 0.1% (by weight dough) to about 60% (by weight dough) non-vegetable protein material. More preferably, the dough includes from about 10% (by weight dough) to about 40% (by weight dough) non-vegetable protein material. Most preferably, the dough includes from about 15% (by weight dough) to about 35% (by weight dough) non-vegetable protein material. The quality of the leavened snack product is typically adversely affected by substantially high levels of non-vegetable protein materials in the dough. For example, as the level of non-vegetable protein material in the dough increases, it typically becomes more difficult to form a consistent dough mixture having the desired properties for further processing, such as visco-elasticity and cohesiveness. The inventors have advantageously discovered, however, that a leavened snack product may be produced according to the processes described herein having high levels of non-vegetable protein material.

As utilized herein, non-vegetable protein material refers to meat, meat by-products, or dehydrated meat material. The term “meat” is understood to apply not only to the flesh of cattle, swine, sheep, and goats, but also horses, whales, and other mammals, along with poultry and fish and shellfish. The term “meat by-products” is intended to refer to those non-rendered parts of the carcass of slaughtered animals including but not limited to mammals, poultry, and the like. The term “dehydrated meat materials” refers to meat materials which are substantially free of moisture, such as dried meats or jerky-type products.

The percentage of meat protein in meats, meat by-products, and dehydrated meat materials is relatively variable, typically depending on the overall composition of the meat material. For example, the amount of meat protein in 95% lean beef is typically from about 20% (by weight) to about 21% (by weight) meat protein. By way of another example, the amount of meat protein in 90% lean beef is typically from about 19% (by weight) to about 20% (by weight) meat protein. By way of another example, the amount of meat protein in 80% lean beef is typically fiom about 18% (by weight) to about 19% (by weight) meat protein. By way of another example, the amount of meat protein in 70% lean beef is typically from about 15% (by weight) to about 16% (by weight) meat protein. By way of another example, the amount of meat protein in SlimJim® meat snacks is typically from about 14% (by weight) to about 20% (by weight) meat protein. By way of another example, the amount of meat protein in meat jerky is typically from about 18% (by weight) to about 35% (by weight) meat protein.

Examples of meat which may be used as a component in the dough are mammalian meat such as beef, veal, pork, and horsemeat, and the fleshy tissue from antelope, bison, cows, deer, elk, and the like, of varying fat content (e.g., 95% lean, 80% lean, 75% lean, 50% lean, 30% lean, etc.). Poultry meat which may be used as a component in the dough includes chicken, turkey, duck, goose, and the like, and the various parts and skins thereof, which may or may not be mechanically deboned. Meat also includes the flesh of fish and shell fish. Meat also includes ground or processed meat of any of the above mammals and fish. Meat also includes striated muscle which is skeletal or that which is found, for example, in the tongue, diaphragm, heart, or esophagus, with or without accompanying overlying fat and portions of the skin, sinew, nerve and blood vessels which normally accompany the meat flesh. Examples of meat by-products are organs and tissues such as skins (e.g., pork skins or rinds), lungs, spleens, kidneys, brain, liver, blood, bone, partially defatted low-temperature fatty tissues, stomachs, intestines free of their contents, and the like. Poultry by-products include non-rendered clean parts of carcasses of slaughtered poultry such as heads, feet, and viscera, free from fecal content and foreign matter. Examples of dehydrated meat material includes such materials as dried meat products, meat jerky, and sausage products such as SlimJim® meat snacks, summer sausage, and the like.

Other Dough Ingredients

In addition to the vegetable protein material and the non-vegetable protein material described above, the dough optionally includes a leavening agent. Leavening agents are used to provide the internal expansion or rise of the product during baking. Preferably, the dough comprises from about 0.25% (by weight dough) to about 5% (by weight dough) of a leavening agent. More preferably, the dough comprises from about 0.5% (by weight dough) to about 3% (by weight dough) of a leavening agent. Most preferably, the dough comprises from about 0.5% (by weight dough) to about 2.5% (by weight dough) of a leavening agent.

In one embodiment, the leavening agent is a yeast or yeast food. The use of yeasts and yeast foods as leavening agents in the food producing industry is well known in the art. The dough of the present disclosure may be leavened, for example, by adding a suitable yeast culture to the dough, such as a culture of Saccharoniyces cereioisiae (baker's yeast), e.g. a commercially available strain of S. cerevisiae.

In another embodiment, the leavening agent is a chemical leavening agent. Generally speaking, chemical leavening is brought about by the action of gas produced by an acid and an alkali. Most chemical leavening agents are similar in their action, and they typically are composed of an acid and an alkali. When the acid and the alkali in the dough are brought together in the presence of moisture and heat, carbon dioxide is produced. As the carbon dioxide expands, it causes the dough to rise. Various chemical leavening agents for making leavened snack products are also well known in the food processing industry. Examples of chemical leavening agents which may be used include alkaline materials and acidic materials such as sodium bicarbonate, ammonium carbonate, ammonium bicarbonate, calcium acid phosphate, sodium acid pyrophosphate, diammonium phosphate, tartaric acid, mixtures thereof, and the like. In an alterative embodiment, yeast and yeast foods may be used in combination with one or more of the above chemical leavening agents.

As discussed in further detail below, a hydrating solution is used to mix the vegetable protein material, the non-vegetable protein material, leavening agents, and other ingredients to form the dough. Preferably, the hydrating solution comprises water. More preferably, the hydrating solution is water. Typically, the dough includes from about 10% (by weight dough) to about 60% (by weight dough) hydrating solution. Preferably, the dough includes fiom about 15% (by weight dough) to about 50% (by weight dough) hydrating solution. More preferably, the dough includes fiom about 20% (by weight dough) to about 40% (by weight dough) hydrating solution.

In addition to the above ingredients, the dough also optionally includes flour. Preferably, the flour is a cereal flour. Generally speaking, flour provides the structure in leavened products produced from dough. Preferably, the dough includes from about 0.1% (by weight dough) to about 60% (by weight dough) flour. More preferably, the dough includes from about 20% (by weight) to about 50% (by weight) flour. Still more preferably, the dough includes from about 30% (by weight) to about 40% (by weight) flour.

Common flours such as wheat flour contain proteins that interact with each other when hydrated (e.g., with water), forming gluten. Gluten has an elastic framework which stretches to contain the expanding leavening gases during rising. The protein content of a flour also affects the strength of a dough. Various flour varieties contain varying amounts of the gluten-forming proteins. Suitable flours for use in the dough of the present disclosure include such flours as wheat flour, corn flour, rice flour, potato flour, oat flour, barley flour, tapioca flour, rye flour, soy flour, sorghum flour, mixtures thereof, and the like.

In addition to the above ingredients, the dough also optionally includes starch. Starch, like flour, functions in a number of ways in the dough. For example, at elevated temperatures starch gelatinizes; that is, it absorbs water and begins to irreversibly swell. Gelatinization of starch contributes to the texture and structure of the leavened snack product produced by the dough. By way of another example, starch facilitates the binding of the various dough ingredients together to form a substantially homogenous dough. The presence of starch in the dough also helps provide a light crisp texture in the leavened product. Preferably, the dough includes from about 1% (by weight dough) to about 20% (by weight dough) starch. More preferably, the dough includes from about 5% (by weight dough) to about 15% (by weight dough) starch. Still more preferably, the dough includes from about 8% (by weight dough) to about 12% (by weight dough) starch. Suitable starches for use in the dough of the present disclosure include, for example, corn starch, wheat starch, tapioca starch, potato starch, rice starch, sorghum starch, mixtures thereof, and the like.

In one embodiment, the starch is a modified starch. Preferably, the starch is a modified corn starch. Modified starches are typically native starches that have been chemically modified to enhance or alter certain functionalities such as water absorption, water binding, shear resistance, heat resistance, freeze-thaw stability, combinations thereof, and the like. Modified food starches are well known in the art and are described, for example, by Bemiller, J. N. and Whistler, R. L., “Carbohydrates” Ch. 4 in Food Chemistry, 3d. edition, Fennema, O. R., Marcel Dekker, inc. (Eds.), pp. 201-204, New York (1996). Modifications to food starch include, for example, crosslinking of polymer chains, non-cross-linking derivatization, depolymerization and pregelatinization. Chemical reactions frequently used to produce modified food starches include, for example, esterification with acetic anhydride, succinic anhydride, the mixed anhydride of acetic and adipic acids, 1-octenylsuccinic anhydride, phosphoryl chloride, sodium trimetaphosphate, sodium tripolyphosphate, and monosodium orthophosphate; etherification with propylene oxide; acid modification with hydrochloric and sulfuric acids: bleaching with hydrogen peroxide, peracetic acid, potassium permanganate, and sodium hypochlorite; oxidation with sodium hypochlorite; and various combinations of these reactions. A most preferred modified food starch is corn starch modified by cross-linking or pregelatinization. The modified food starches may be produced by methods known to the art and/or may be purchased commercially from various sources.

In addition to the above ingredients, the dough also optionally contains a sugar. Exemplary sugars include sucrose, fructose, lactose, dextrose, galactose, maltodextrins, corn syrup solids, glucose syrup, mixtures thereof, and the like. Sugar is typically used as a flavoring agent to enhance the flavor of the leavened snack product. Sugar, however, has numerous functions in the dough other than providing sweetness. For example, sugar may help the leavening agent begin producing gas for raising the dough. Sugar may also slow yeast fermentation; in sweet doughs, the rising time is typically longer. Sugar may also help soften and/or tenderize the dough, and may help it to brown when heated. Reducing sugars, such as fructose, maltose, lactose, and dextrose, or mixtures of reducing sugars may be used to promote browning. The dough may include from about 0.1% (by weight dough) to about 30% (by weight dough) sugar. Preferably, the dough includes from about 1% (by weight) to about 15% (by weight dough) sugar. More preferably, the dough includes from about 3% (by weight dough) to about 8% (by weight dough) sugar.

The dough may also optionally include other conventional dough ingredients, e.g.: other proteins, such as milk or milk powder, and gluten; eggs (either whole eggs, egg yolks or egg whites); shortening such as granulated fat or oil; an oxidant such as ascorbic acid, potassium bromate, potassium iodate, azodicarbonamide (ADA) or ammonium persulfate; a reducing agent such as L-cysteine; or a salt such as sodium chloride, calcium acetate, sodium sulfate or calcium sulfate. The dough also optionally includes an emulsifier such as mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, phospholipids, lecithin and lysolecithin. Such ingredients are commonly employed in dough formulations.

Conventional snack flavoring agents and additives may also be readily mixed into the dough at any point during the formation of the same. These agents and additives may be soluble in the hydrating solution, or may be insoluble and visible in or on the dough after it is formed and/or after it undergoes further processing.

Commonly-used flavoring agents in snack food processing include, for example, pizza, barbecue, sour cream, chives, onion, garlic, italian flavoring, smoke flavoring, teriyaki flavoring, sweet and sour flavoring, hot seasoning, spicy seasoning, butter, vinegar, ranch, bacon, chicken, beef, cheese, ham, and nacho flavorings, dried vegetable flakes and herb flakes such as pepper, basil, thyme, peppermint, dried tomato, and parsley flakes, condiment flakes, spices, cheese powders such as cheddar cheese and nacho cheese seasoning powders, and mixtures thereof. These flavoring agents generally enhance the flavor of the leavened snack product, provide a color property to the leavened snack product and/or provide structure to the dough used in producing the leavened snack product. When present, the dough includes from about 0.1% (by weight) to about 5% (by weight) flavoring agent. Alternatively, if the flavoring agents are applied to the leavened snack product in combination with an oil or edible adhesive, the leavened snack product typically includes from about 0.1% (by weight leavened snack product) to about 20% (by weight leavened snack product) flavoring agent/oil or edible adhesive combination.

Alternatively, the above-described flavoring agents may be sprinkled, brushed, or otherwise applied to the product during other steps in the process. For example, at various points during the processes described herein, the product may be sprayed with oil or an edible no-fat, low-fat or reduced fat edible adhesive. The oil or adhesive is used to increase palatability and to provide a medium for the adhesion of the above-described flavoring agents. The flavoring agents may be applied after spray coating with the oil or adhesive or they may be applied together, for example, as a slurry. A slurry coating applicator such as a Coatronic applicator (Allen International, Newberg, Oreg.), or a rotating disk applicator such as sold by Arcall Ltd., (Dorset, England), for example, may be used. The products may also be optionally subjected to tumbling during the spraying and/or during the addition of the particulate additives and agents.

In addition to the flavoring agents, the dough may also optionally include one or more curing and/or preserving agents. Curing and/or preserving agents are generally used to prevent meats from spoiling when cooked or smoked at relatively low temperatures (e.g., under about 60° C. (140° F.)). Curing and/or preserving agents are also generally used to prevent growth of microorganisms, for adding flavor, and for preserving the color of the meat. Accordingly, the use of such preservatives and/or curing agents may be particularly useful in leavened snack products including non-vegetable protein material such as meat, meat by products, and dehydrated meat material. Examples of one or more preservatives and/or curing agents which can be included in the dough are benzoic acid, the sodium and other salts of benzoic acid, the sodium, calcium and other salts (i.e., propionates) of propionic acid, sorbic acid, the potassium, calcium, sodium and other salts (i.e., sorbates) of sorbic acid, diethyl pyrocarbonate and menadione sodium bisulfate, and sodium nitrite. One particularly suitable curing and/or preserving composition is Prague Powder #I (also known as Insta-Cure #1 or Modern Cure #1), which is a mixture of sodium nitrite (6.25%) and salt (93.75%). Another suitable curing and/or preserving composition is Prague Powder #2 (also known as Insta-Cure #2 or Modern Cure #2), which is a mixture of sodium nitrite (1 oz) and sodium nitrate (0.64 oz) per one pound of salt. When present, the dough typically includes from about 0.1% (by weight) to about 5% (by weight) of one or more curing and/or preserving agents.

Process for Producing the Leavened Snack Product

Typically, the non-vegetable protein material is first comminuted prior to mixing with the other ingredients. A bowl cutter, which is used extensively in the food processing industry, is generally preferred. Suitable bowl cutters for use in the present disclosure are commercially available from such manufacturers as Seydelmann (Germany), Kramer & Grebe (Germany), and Fatosa (Spain). By way of example, when dehydrated meat materials such as meat jerky or SlimJim® meat snacks are employed as the non-vegetable protein material, they are preferably mixed or ground into a smooth paste or powder. Preferably, the non-vegetable protein material is finely ground into granules or particles of uniform size and consistency. More preferably, the non-vegetable protein material is ground such that the granules or particles will pass through a U.S. #10 mesh sieve.

The vegetable protein material is then added to the ground particulate non-vegetable protein material and mixed, for example, with a Hobart mixer, which is well known in the food processing industry. The vegetable protein material and the non-vegetable protein material are preferably mixed for about 15 seconds to about 10 minutes. More preferably, the vegetable protein material and the non-vegetable protein material are mixed for about 30 seconds to about 5 minutes. Still more preferably, the vegetable protein material and the non-vegetable protein material are mixed for about I minute to about 3 minutes.

The various other ingredients (e.g., leavening agents, cereal flours, starches, sugar, flavoring agents, etc.), if employed, may then be added to the mixture containing the vegetable protein material and the non-vegetable protein material. This composition is then further mixed, typically for about 30 seconds to about 15 minutes; more preferably for amount I minute to about 5 minutes; still more preferably from about 1 minute to about 3 minutes.

Once the dry ingredients have been substantially mixed, the hydrating solution is added and mixed with the dry ingredients to form the dough. Suitably, the dough is formed by contacting the vegetable protein material, the non-vegetable protein material, and the other ingredients with a sufficient amount of a hydrating solution comprising water. In one preferred embodiment, the hydrating solution is water. As used herein, the term hydrating generally refers to the introduction of water to the vegetable protein material and the non-vegetable protein material. Suitably, the vegetable protein material and the non-vegetable protein material are contacted with the hydrating solution until the hydrating solution is uniformly absorbed throughout the vegetable protein materials and the non-vegetable protein materials, forming a dough. More specifically, after hydrating is completed, the vegetable protein material and the non-vegetable protein material will typically have no visible dry spots. Typically, the moisture content in the dough is from about 20% (by weight) to about 40% (by weight). After mixing, the non-vegetable protein material may be distinguishable from the vegetable protein material. For example, the non-vegetable protein material particles may be relatively coarse as compared to the vegetable protein materials and the other ingredients. Alternatively, the vegetable protein material, the non-vegetable protein material, or any other ingredient may be indistinguishable in the mixture. Preferably, the vegetable protein material and the non-vegetable protein material are mixed with the hydrating solution until the mixture is a machinable dough; that is, the dough can be further processed using conventional dough processing equipment. For example, the dough can be sheeted and cut to certain sizes without being stuck to or tore by conventional sheeting and cutting equipment.

Generally, a Hobart mixer may be used to mix the various ingredients to form the dough. The length of time required to mix the various ingredients is generally dependent on the type and speed of the mixer. For example, the time required to mix the dough will be shorter if a high speed/high shear mixer is used. Using a Hobart mixer on the “low” setting, the dough is preferably mixed for about 30 seconds to about 15 minutes; more preferably for about 1 minute to about 10 minutes; still more preferably from about 2 minutes to about 4 minutes.

As will be understood by one of ordinary skill in the art, the dough may be formed by mixing the various ingredients in any particular order. For example, the vegetable protein material, the comminuted non-vegetable protein material, and the hydrating solution may be contacted with each other at substantially the same time and mixed to form the dough. By way of another example, the vegetable protein material may be contacted with the hydrating solution first and mixed, and this mixture may be further contacted with the non-vegetable protein material and mixed to produce the dough, and vice versa. Alternatively, the vegetable protein material and the non-vegetable protein material may be first mixed (e.g., dry mixed), and this mixture may be further contacted with the hydrating solution to produce the dough. The various other ingredients (e.g., leavening agents, cereal flours, starches, sugar, flavoring agents, etc.) in the dough may similarly be mixed with the vegetable protein material, non-vegetable protein material, and hydrating solution in any particular order at any particular point in the dough formation process.

After the dough is formed, it is preferably allowed to rest for a period of time. This step is well known in the dough- and leavened food processing industry, and is also known as “relaxing” the dough or “giving floor time” to the dough. The relaxing period, or floor time, is the period of time from when a dough is done mixing until it is further processed. Relaxing the dough is a critical step in the production of leavened snack products. During this period of time, the hydrating solution in the dough is absorbed by the dry ingredients in the dough, enhancing the softness and pliability of the dough. The dough may also undesirably tighten during the relaxing period, making it more difficult to work with during subsequent processing steps, such as sheeting.

The time period that the dough is allowed to rest is not narrowly critical for purposes of the present disclosure. Generally speaking, however, the resting period is sufficient to allow at least some of the dry ingredients to absorb moisture in the dough, promoting softness and pliability. Also, the resting period should not be so long as to allow the dough to substantially tighten. Preferably, the dough is allowed to rest for about 1 minute to about 30 minutes; more preferably from about 3 minutes to about 20 minutes, most preferably from about 5 minutes to about 15 minutes.

The temperature and relative humidity of the environment in which the dough is allowed to stand is also not narrowly critical for purposes of the present disclosure. Generally, the dough is allowed to rest at a temperature of from about 15.5° C. (60° F.) to about 49° C. (120° F.); more preferably from about 21° C. (70° F.) to about 38° C. (100° F.); most preferably from about 27° C. (80° F.) to about 32° C. (90° F.). The dough is preferably allowed to rest at a relative humidity of from about 20% to about 100%; more preferably from about 60% to about 95%; most preferably from about 80% to about 90%.

After the dough is formed and/or allowed to rest, the dough is processed (e.g., cut, sliced, or otherwise portioned or sectioned) into individual wafers. Depending on the shape of the dough, various shapes may be produced upon processing such as, for example, square wafers, round wafers, rectangular wafers, triangular wafers, and the like. The dough is typically processed into individual wafers being from about 0.5 millimeters to about 4 millimeters thick, preferably from about 2 millimeters to about 3 millimeters thick.

One particularly preferred method of processing the dough into individual wafers is by sheeting the dough and cutting the dough. Suitable “sheeting and cutting” (i.e., sheeting and separating) equipment is well known in the food processing industry and includes, for example, Rondo sheeters and sheeter/cutters (commercially available from Rondo Inc., Moonachie, N.J.) and the Somerset® CDR-2000 Dough Sheeter (commercially available from Somerset Industries, Inc. (North Billerica, Mass.)).

After the dough has been separated into individual wafers, either by sheeting the dough and cutting the dough or some other method, such as slicing, the individual wafers are heated to produce the leavened snack product. Conventional leavened snack product heating methods well known in the food processing industry may be utilized to produce the leavened snack product of the present disclosure. The heating may be conducted, for example, with hot air drying, hot oil or deep fat frying, microwave heating, oven heating, heating with a puffing gun such as those used in the cereal industry, with hot sand, combinations thereof, and the like.

Prior to hot oil (deep fat) frying, the individual wafers may be optionally conditioned to allow the moisture in the individual wafers to equilibrate. Following conventional sheeting and cutting processes, the moisture content in particular regions of the individual wafer may vary. For example, the inner core portion of the individual wafer may have a higher moisture content than the outer portions (e.g., the surface) of the individual wafers. If the moisture content of the inner portion is relatively high, the wafer may substantially puff up upon frying due to the flashing of the moisture to steam. The individual wafers are typically conditioned by resting on one or more conveyor belts for a period of time prior to the heating operation. Typically, the individual wafers are conditioned for about 2 minutes to about 20 minutes. The exact procedure used to condition the individual wafers is not narrowly critical and suitable conditioning processes are well known to one of skill in the art.

The heating step is performed to produce a leavened snack product having a desired moisture content. As the individual wafers are heated, the moisture level is reduced. The individual wafers are desirably heated to a sufficient level of moisture to provide a leavened snack product having a crisp, crunchy texture.

In order to achieve the desired level of crispiness and crunchiness, the moisture level of the leavened snack product is preferably not too high or too low. For example, leavened snack products that have a moisture content of greater than about 10% (by weight leavened snack product) tend to lose their crispiness and become dense and hard. Preferably, the individual wafers are heated to produce a leavened snack product having a moisture content of from about 0.5% (by weight leavened snack product) to about 10% (by weight leavened snack product). More preferably, the individual wafers are heated to produce a leavened snack product having a moisture content of from about 1% (by weight leavened snack product) to about 6% (by weight leavened snack product); most preferably from about 1.5% (by weight leavened snack product) to about 3.5% (by weight leavened snack product).

In one embodiment, the individual wafers are fried in hot oil to produce the leavened snack product. Preferably, the individual wafers are fried in oil at a temperature of from about 121° C. (250° F.) to about 260° C. (500° F.). More preferably, the individual wafers are fried in oil at a temperature of from about 149° C. (300° F.) to about 232° C. (450° F.); most preferably from about 177° C. (350° F.) to about 191° C. (375° F.). Various conventional cooking oils such as vegetable oil, canola oil, soybean oil, sunflower oil, and the like may be used to fry the wafers to produce the leavened snack product. Animal-based fats such as tallow and lard may also be used as the frying medium.

During the hot oil frying process, the majority of free water in the wafers will be replaced with oil. It is desirable to minimize this oil uptake, as this will lead to a healthier, low fat snack product. As such, the frying time of the individual wafers is generally short, typically from about 10 seconds to about 200 seconds. More preferably, the individual wafers are fried in oil for about 20 seconds to about 150 seconds; still more preferably from about 40 seconds to about 120 seconds.

Another suitable heating method for producing the leavened snack products includes using a microwave oven. Microwave oven heating may also be used in combination with conventional oven heating. By way of example, the individual wafers can be microwaved at from about from about 900 MHz to about 2500 MHz; preferably at about 915 MHz.

Yet another suitable heating method for producing the leavened snack products includes using an oven such as an air impingement oven or convection oven. Various commercially available hot air impingement ovens may be used, such as those manufactured by Werner & Pfleider, Ramsey, N.J., or APV Baker, Inc., Grand Rapids, Mich. Preferably, the individual wafers are heated in a convection oven. Suitable convection ovens include direct or indirect-fired convention ovens, using a single pass or triple pass. Conventional convection ovens and processes for producing leavened snack products are well known in the art. In one embodiment, the individual wafers are heated in a convection oven at about 121° C. (250° F.) to about 260° C. (500° F.) for from about 5 minutes to about 20 minutes.

Yet another suitable heating method for producing the leavened snack products includes using a smokehouse. There are numerous smokehouse and/or convection oven cooking and smoking procedures known to those of skill in the art, any of which may be used to produce the leavened snack product. For example, the temperature and humidity of the smokehouse may be varied considerably. Preferably, at least some moisture is present in the convection oven to prevent case hardening of the individual wafers. Case hardening may occur if the outer surface(s) of the individual wafer dry too rapidly and become hard. This may prevent the internal portion of the individual wafers from drying to the desired moisture content.

One method of monitoring the temperature and humidity of a smokehouse is through the use of a dry bulb/wet bulb thermometer. The dry bulb/wet bulb thermometer monitors the temperature of the smokehouse using two thermometers positioned next to each other, one dry, and the other inside a moist piece of cloth. The difference between the dry and wet bulb temperatures can be used to calculate the relative humidity of the smokehouse, e.g., using a psychrometric chart. The wet bulb temperature is essentially a measurement of the temperature at which moisture is evaporating in the oven. The wet bulb temperature in an oven can be controlled in one of two ways. The smokehouse control system can either modulate fresh air and/or exhaust dampers open and closed to regulate the amount of evaporated moisture from the individual wafers that is retained in the oven. Alternatively, the smokehouse control system can control the wet bulb temperature by injecting steam or atomized water into the oven as a humidity source.

The leavened snack product produced according to the foregoing process generally comprises from about 0.2% (by weight leavened snack product) to about 80% (by weight leavened snack product) vegetable protein; more preferably from about 2% (by weight leavened snack product) to about 50% (by weight leavened snack product) vegetable protein; still more preferably from about 5% (by weight leavened snack product) to about 40% (by weight leavened snack product) vegetable protein; still more preferably from about 5% (by weight leavened snack product) to about 20% (by weight leavened snack product) vegetable protein; most preferably from about 5% (by weight leavened snack product) to about 15% (by weight leavened snack product) vegetable protein.

The leavened snack product produced according to the foregoing process also generally compromises from about 0.2% (by weight leavened snack product) to about 30% (by weight leavened snack product) non-vegetable protein; more preferably from about 0.5% (by weight leavened snack product) to about 20% (by weight leavened snack product) non-vegetable protein; still more preferably from about 1% (by weight leavened snack product) to about 20% (by weight leavened snack product) non-vegetable protein; still more preferably from about 1% (by weight leavened snack product) to about 15% (by weight leavened snack product) non-vegetable protein; most preferably from about 1% (by weight leavened snack product) to about 13% (by weight leavened snack product) non-vegetable protein.

One method of measuring the vegetable protein and non-vegetable protein content is by the Kjeldahl or Kjel-Foss analysis. For example, the Nitrogen-Ammonia-Proteii Modified Kjeldahl Method according to AOCS Methods Bc4-91 (1997), Aa 5-91 (1997), and Ba 4d (1997) may be used to determine the protein content of the leavened snack product.

The leavened snack product produced according to the foregoing process also generally comprises from about 1% (by weight leavened snack product) to about 6% (by weight leavened snack product) moisture. More preferably, the leavened snack product comprises from about 1% (by weight leavened snack product) to about 4% (by weight leavened snack product) moisture; most preferably from about 2% (by weight leavened snack product) to about 3% (by weight leavened snack product) moisture.

The leavened snack product may also comprise from about 0.1% (by weight leavened snack product) to about 20% (by weight leavened snack product) of a flavoring agent. More preferably, the leavened snack product comprises from about 1% (by weight leavened snack product) to about 15% (by weight leavened snack product) of a flavoring agent. As noted above, the flavoring agent may be combined with an oil or other edible adhesive. Exemplary flavoring agents include savory flavoring agents such as barbecue, cheese, smoke, and the like, or sweet flavoring agents such as cinnamon, fruit, graham cracker, chocolate, and the like.

In one embodiment, the leavened snack products produced by the above processes yield a round cracker having a diameter of from about 3 millimeters to about 4 millimeters; preferably about 3.5 millimeters. The leavened snack products are typically from about 2 millimeters to about 4 millimeters thick; preferably about 3 millimeters. The leavened snack product typically weighs from about 1.5 g to about 2.0 g. The texture and appearance of the leavened snack products produced according to the processes described herein typically resemble that of conventional leavened snack products such as, for example, Nabisco “Wheat Thins®” snack crackers (Kraft Foods North America), Nabisco “Better Cheddars®” snack crackers (Kraft Foods North America), Keebler “Wheatables®” snack crackers (Kellogg Snacks), and Keebler “Cheez-It®” snack crackers (Kellogg Snacks).

### EXAMPLES

### Example 1

### Preparation of a Leavened Snack Product

In this Example, various high protein leavened snack products are produced using the dough formulations set forth in Table 1:

TABLE 1
Dough Formulations

| | SAMPLE | | | | | | |
|---|---|---|---|---|---|---|---|
| DOUGH | 1 | 2 | 3 | 4 | 5 | 6 | 7 |
| Pastry Flour (g) | 0 | 0 | 191.6 | 151.6 | 108.4 | 69.8 | 85.8 |
| Whole Wheat | 191.6 | 151.6 | 0 | 0 | 0 | 0 | 0 |
| Flour (g) | | | | | | | |
| Non-vegetable | 100.0 | 140.0 | 100.0 | 140.0 | 40.0 | 80.0 | 60.0 |
| Protein Material (g) | | | | | | | |
| Water (g) | 140.0 | 122.50 | 130.0 | 120.0 | 60.0 | 40.0 | 60.0 |
| Modified Corn | 48.0 | 48.0 | 48.0 | 48.0 | 24.0 | 24.0 | 24.0 |
| Starch (g) | | | | | | | |
| Soy Protein | 32.0 | 32.0 | 32.0 | 32.0 | 10.0 | 10.0 | 16.0 |
| Isolate (g) | | | | | | | |
| Sugar (g) | 20.0 | 20.0 | 20.0 | 20.0 | 9.4 | 12.0 | 10.0 |
| Salt (g) | 0 | 0 | 0 | 0 | 4.0 | 0 | 0 |
| Sodium acid | 3.6 | 3.6 | 3.6 | 3.6 | 1.8 | 1.8 | 1.8 |
| pyrophosphate (g) | | | | | | | |
| NaHCO₃ (g) | 4.8 | 4.8 | 4.8 | 4.8 | 2.4 | 2.4 | 2.4 |
| TOTAL (g) | 540 | 522.5 | 530 | 520 | 260 | 240 | 260 |

The high protein leavened snack products are prepared by first grinding the non-vegetable protein material (SlimJim® meat snacks) in a Hobart mixer on the “low” setting for about 1 minute to form a fine powder. The remaining dry ingredients (flour (pastry flour (Harvest Moon soft wheat flour, commercially available from BakeMark Ingredients (East) Inc., Schaumburg, Ill.) or whole wheat flour (Stone ground fine whole wheat flour, commercially available from ConAgra Foods, Omaha, Nebr.)), corn starch, soy protein isolate (SUPRO® 661, commercially available from The Solae Company, St. Louis, Mo.), sugar, salt, sodium acid pyrophosphate (SAPP), and NaHCO₃) are added to the powdered non-vegetable protein material and the resulting mixture is mixed using the Hobart mixer for about 1-3 minutes. The water (about 21° C.) is then added to the mixture and the mixture is further mixed for about 3 minutes to form the dough. The moisture content of the dough is about 23-31% (by weight). The dough is then wrapped in a plastic bag and allowed to rest in a proof box for about 10 minutes. The proof box is maintained at about 27° C. (80° F.) and about 90% relative humidity.

After resting, about 100 g of the dough is kneaded by hand to about a ½ inch thick sheet. The kneaded dough is then fed into a dough sheeter (Somerset® CDR-2000 Dough Sheeter). The two sets of sheet rolls are set up in sequence, and the clearances of the top roll and bottom roll are about 5 mm and about 2 mm, respectively. The thickness of the dough is about 2 mm. After sheeting, the sheeted dough is rested on a baking pan and cut with a hand-held cutter to individual wafers of various shapes and sizes (round: 35 mm diameter; square: 3.5 mm×3.5 mm; triangle: 4 mm×4 mm×4 mm). The individual wafers are then baked in a rotary oven at about 177° C. (350° F.) for about 10-15 minutes. After baking, the leavened snack products are allowed to cool for optional vegetable oil and/or vegetable oil and seasoning application.

The various leavened snack products produced from the above dough formulations include the amounts of vegetable protein and non-vegetable protein as set forth in Table 2:

TABLE 2
Leavened Snack Product Composition

| | LEAVENED SNACK PRODUCT | | | | | | |
|---|---|---|---|---|---|---|---|
| | 1 | 2 | 3 | 4 | 5 | 6 | 7 |
| Vegetable Protein | 11.3 | 10.5 | 11.3 | 10.5 | 9.1 | 7.5 | 10.9 |
| Content (% by weight | | | | | | | |
| leavened snack product) | | | | | | | |
| Non-Vegetable Protein | 5.2 | 7.3 | 5.2 | 7.3 | 4.2 | 8.4 | 6.3 |
| Content (% by weight | | | | | | | |
| leavened snack product) | | | | | | | |

### Example 2

### Preparation of a Leavened Snack Product

In this Example, a high protein leavened snack product is produced using the dough formulation set forth in Table 3:

TABLE 3
Dough Formulation

| | SAMPLE |
|---|---|
| DOUGH | 1 |
| Pastry Flour (g) | 0 |
| Whole Wheat Flour (g) | 116.0 |
| Non-vegetable Protein Material (g) | 40.0 |
| Water (g) | 60.0 |
| Modified Corn Starch (g) | 20.0 |
| Soy Protein Isolate (g) | 10.0 |
| Sugar (g) | 10.0 |
| Salt (g) | 4.0 |
| TOTAL (g) | 260 |

The dough including the ingredients listed in Table 3 is produced according to the process described above in Example 1. In this Example, however, ground beef (50% lean; 38.7% moisture) is used as the non-vegetable protein material. The dough has a moisture content of about 29%. The dough is sheeted, cut, and baked according to the process described in Example 1. The resulting leavened snack product has a vegetable protein content of about 9.4% (by weight leavened snack product) and a non-vegetable protein content of about 2.4% (by weight leavened snack product).

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A process for producing a leavened snack product, the process comprising:
forming a dough comprising from about 0.1% (by weight dough) to about 60% (by weight dough) vegetable protein material, from about 0.1% (by weight dough) to about 60% (by weight dough) non-vegetable protein material, and a hydrating solution;
separating the dough into individual wafers; and
heating the individual wafers to produce the leavened snack product.

2. The process as set forth in claim 1 wherein the dough comprises from about 2% (by weight dough) to about 50% (by weight dough) vegetable protein material.

3. The process as set forth in claim 1 wherein the soy protein materials are soy protein isolates.

4. The process as set forth in claim 1 wherein the dough comprises from about 10% (by weight dough) to about 40% (by weight dough) non-vegetable protein material.

5. The process as set forth in claim 1 wherein the non-vegetable protein material is selected from the group consisting of meat, meat by-products, dehydrated meat material, and combinations thereof.

6. The process as set forth in claim 1 wherein the dough comprises from about 10% (by weight dough) to about 60% (by weight dough) hydrating solution.

7. The process as set forth in claim 6 wherein the hydrating solution comprises water.

8. The process as set forth in claim 1 wherein the dough further comprises a leavening agent.

9. The process as set forth in claim 8 wherein the leavening agent is a chemical leavening agent, a yeast, a yeast food, and combinations thereof.

10. The process as set forth in claim 9 wherein the chemical leavening agent is selected from the group consisting of sodium bicarbonate, ammonium carbonate, ammonium bicarbonate, calcium acid phosphate, sodium acid pyrophosphate, diammonium phosphate, tartaric acid, and combinations thereof.

11. The process as set forth in claim 1 wherein the dough is sheeted prior to being separated into individual wafers.

12. The process as set forth in claim 1 wherein the individual wafers are heated in an oven at a temperature of from about 121 ° C. (250° F.) to about 260° C. (500° F.).

13. A leavened snack product comprising:
from about 0.2% (by weight leavened snack product) to about 80% (by weight leavened snack product) vegetable protein;
from about 0.2% (by weight leavened snack product) to about 30% (by weight leavened snack product) non-vegetable protein; and
from about 1% (by weight leavened snack product) to about 6% (by weight leavened snack product) moisture.

14. The leavened snack product as set forth in claim 13 wherein the leavened snack product comprises from about 5% (by weight leavened snack product) to about 40% (by weight leavened snack product) vegetable protein.

15. The leavened snack product as set forth in claim 13 wherein the leavened snack product comprises from about 5% (by weight leavened snack product) to about 15% (by weight leavened snack product) vegetable protein.

16. The leavened snack product as set forth in claim 13 wherein the vegetable protein comprises protein from soy protein materials selected from the group consisting of soy flakes, soy flour, soy grits, soy meal, soy protein concentrates, soy protein isolates, and combinations thereof.

17. The leavened snack product as set forth in claim 16 wherein the soy protein materials are soy protein isolates.

18. The leavened snack product as set forth in claim 13 wherein the leavened snack product comprises from about 1% (by weight leavened snack product) to about 20% (by weight leavened snack product) non-vegetable protein.

19. The leavened snack product as set forth in claim 13 wherein the leavened snack product comprises from about 1% (by weight leavened snack product) to about 10% (by weight leavened snack product) non-vegetable protein.

20. The leavened snack product as set forth in claim 13 wherein the non-vegetable protein comprises protein from the group consisting of meat, meat by-products, dehydrated meat material, and combinations thereof.

21. The leavened snack product as set forth in claim 13 wherein the leavened snack product comprises from about 1% (by weight leavened snack product) to about 4% (by weight leavened snack product) moisture.

22. The leavened snack product as set forth in claim 13 wherein the leavened snack product further comprises from about 0.1% (by weight leavened snack product) to about 20% (by weight leavened snack product) of a flavoring agent.

23. The leavened snack product as set forth in claim 22 wherein the flavoring agent is selected from the group consisting of pizza, barbecue, sour cream, chives, onion, garlic, italian flavoring, smoke flavoring, teriyaki flavoring, sweet and sour flavoring, hot seasoning, spicy seasoning, butter, vinegar, ranch, bacon, chicken, beef, cheese, ham, nacho flavorings, dried vegetable flakes, herb flakes, pepper, basil, thyme, peppermint, dried tomato, parsley flakes, condiment flakes, spices, cheese powders, cheddar cheese and nacho cheese seasoning powders, and mixtures thereof.
